(19) United States
(12) Patent Application Publication
(10) Pub. No.: US 2018/0118132 A1
(43) Pub. Date: May 3, 2018

(54) SUPPORTING MEANS FOR ELECTRONIC DEVICE WITH POWER SUPPLY RETENTION MEANS

(71) Applicant: Nick Derokov, West Babylon, NY (US)

(72) Inventor: Nick Derokov, West Babylon, NY (US)

(21) Appl. No.: 15/787,882

(22) Filed: Oct. 19, 2017

Related U.S. Application Data
(60) Provisional application No. 62/416,211, filed on Nov. 2, 2016.

(51) Int. Cl. B60R 11/02

(52) U.S. Cl. CPC B60R 11/0258; B60R 2011/0056

(57) ABSTRACT

The invention is directed to an assembly for removeably mounting an electronic device to a surface, said assembly comprising a) a base section; b) a device mounting section; and, c) a power supply retention component attached to the base section (a) which releaseably attaches a power supply delivery means thereto.

### FIELD OF THE INVENTION

The present invention relates to mounting apparatuses for electronic devices. More particularly, the invention relates to a mounting apparatus for removably mounting an electronic device, e.g., a cellular phone or GPS to a surface such as the interior of a vehicle.

### BACKGROUND OF THE INVENTION

Electronic devices are being used more and more frequently in vehicles. For example, many people access GPS software using their cellular phone while driving in vehicles and elsewhere. These devices are ideally mounted so as to be portable. These portable devices are advantageous in that that they can be taken from the vehicle and used outside of the vehicle as well.

The mounting of portable devices within vehicles does, however, presents a number of challenges. For example, it is difficult to always mount an electronic device in a location within the vehicle that allows its screen to be easily viewed. Portable electronic devices must be mounted somewhere within the interior of the vehicle, such as on top of the dashboard. This mounting position presents the challenge of mounting the device in an orientation and position that can be readily seen and accessed, which can be especially challenging in the instance of the irregular shaped surfaces that are common to most vehicle interiors. Further, hand-held use of electronic devices such as cell phones in vehicles are facing increasing levels of legal scrutiny when being employed by the driver.

These issues can be exacerbated by the desire to have better and more changeable viewing angles, and the desire to removably mount the device with one hand.

### SUMMARY OF THE INVENTION

The invention is directed to an assembly for removeably mounting an electronic device to a surface, said assembly comprising

a) a base section comprising
i) a suction cup mount removeably attachable to a surface,
ii) an internal rotatable component having a rod projecting therefrom and a ball affixed to the rod, and
iii) a capping component,

wherein internal rotatable component a (ii) is configured between suction cup mount a(i) and capping component a(iii), and

wherein capping component a(iii) is engageably connected to internal rotatable component a(ii) such that circumferential rotation of the capping component a(iii) in a parallel plane relative to the surface results in a pressure being applied to the internal rotatable component a(ii) and also the suction cup mount a(i) in the direction perpendicular to the surface, such that suction cup mount a(i) is affixable to the surface by such circumferential rotation;

b) a device mounting section comprising
i) a rear cap containing at least two ball bearings seated therein and a cavity for at least partially encapsulating the ball from a(ii) to provide for connection of base section (a) to device mounting section (b) and to provide for at least 120° of rotation of device mounting section (b) relative to base section (a),
ii) an interior rotatable disc having a circumferentially diveted side to provide for seating of the ball bearing in rear cap b) (i) and an opposing side having at least two engageable protrusions therefrom, and
iii) a device contacting component having a side containing at least one supermagnet therein, and an opposing side containing receptacles configured to receive engageable protrusions from interior rotatable disc b) (ii),

wherein interior rotatable disc b (ii) is configured between rear cap b(i) and device contacting component a(iii), and

wherein circumferential rotation of device contacting component b (iii) results in a segmented movement of the seated ball bearings in b) (i) against the diveted side of b(ii); and,

c) a power supply retention component attached to the base section (a) which releaseably attaches a power supply delivery means thereto.

### BRIEF DESCRIPTION OF THE FIGURES

FIG. 1 is a view of the bottom of the suction cup of the base section.

FIG. 2 is a top view of the suction cup portion of the base section that faces away from the surface.

FIG. 3 is a side view of the suction cup of the base section showing how it is affixed to a curved surface.

FIG. 4 is a bottom view of the internal rotatable component portion of the base section which faces the suction cup section and the surface.

FIG. 5 is a bottom view of the internal rotatable component portion of the base section which illustrates the circumferential fingers which faces the suction cup section and the surface.

FIG. 6 is a bottom view of the internal rotatable component portion of the base section which is laid on top of the suction cup portion which configuration is not visible upon connection of these parts.

FIG. 7 is an interior view of the capping component of the base section which faces the surface.

FIG. 8 is a view of the rear of the rear cap of the device mounting section which faces the direction of the mounted device.

FIG. 9 is a view of the interior of the rear cap of the device mounting section facing away from the device.

FIG. 10 is a view of the internal rotatable disc showing the diveted side which is the face facing away from the device.

FIG. 11 is a view of the internal rotatable disc showing the side having protrusions, which view is facing towards the device.

FIG. 12 is a view of a side of the device contacting component facing away from the device which contains receptacles configured to receive engageable protrusions from the interior rotatable disc.

FIG. 13 is a view of the device contacting side of the device contacting component which contains the supermagnets.

FIG. 14 is a photograph of the power supply retention component.

FIG. 15 is a schematic diagram of the power supply retention component.

FIG. 16 is a side view of the power supply retention component.

FIG. 17 is a side view of the power supply retention component and the power supply delivery means retained therein.

FIG. 18 is view of the entire assembly as well as the demonstration of how the power supply means is retained in the power supply retention component and connected to an electronic device.

### DETAILED DESCRIPTION OF THE INVENTION

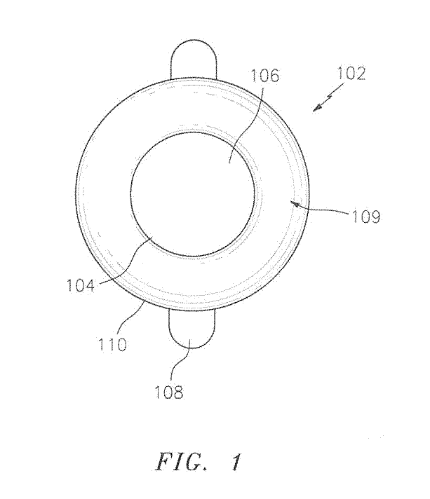

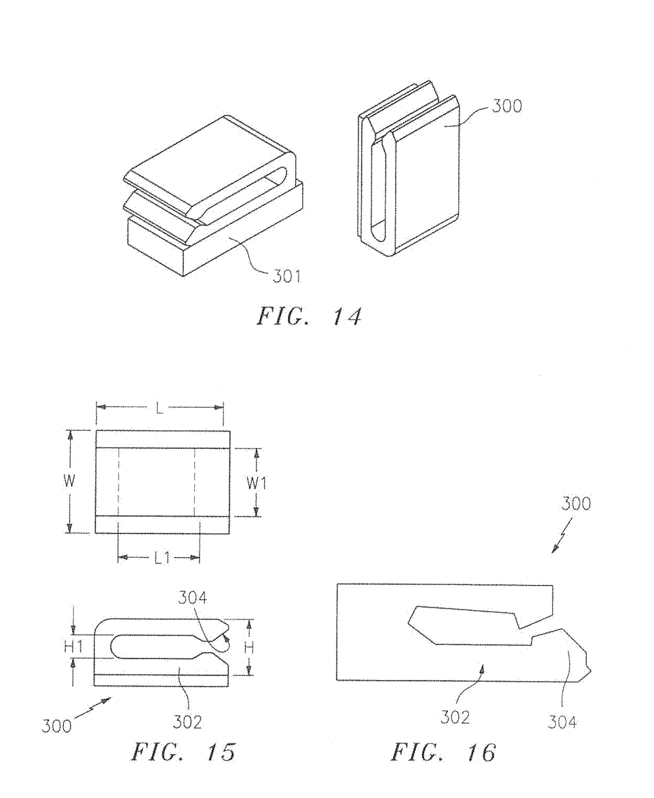

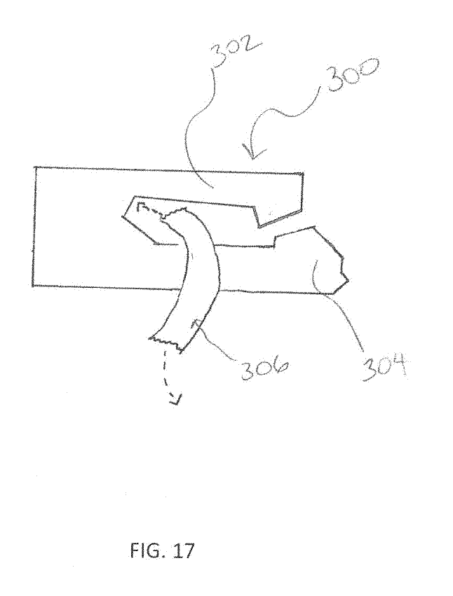

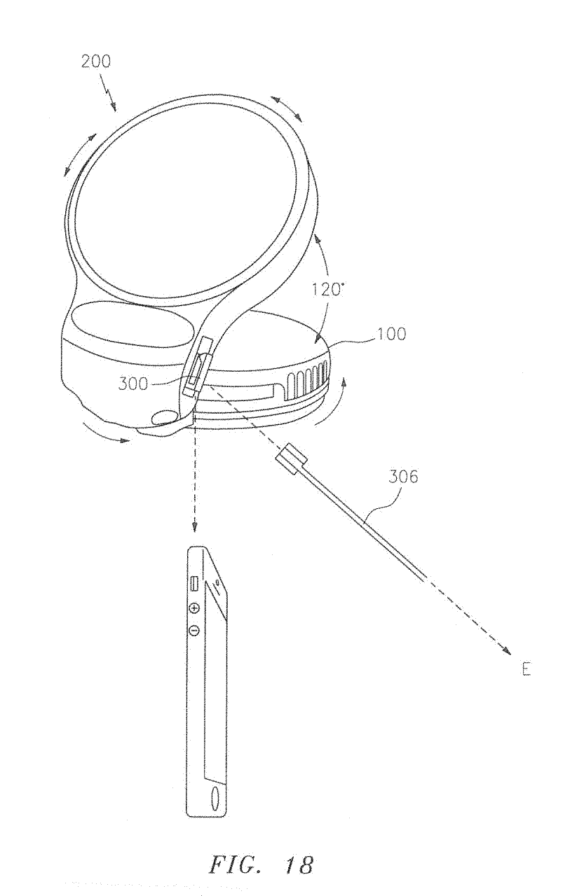

FIG. 18 will be referred to herein along with reference numerals detailed therein, which reference numerals may or may not be detailed in the more specific FIGS. 1-17, as detailed portions of the entire assembly shown in FIG. 18 are detailed in their location, operation and interconnected nature in FIGS. 1-17.

FIG. 1 shows the bottom of the suction cup mount 102 which is the lowermost region of the base section 100 of the assembly show. The suction cup mount 102 has a surface contacting side 104 which contains an air pocket section 106, tabs 108, an adhesive 109, which are located opposite the suction cup top side 110.

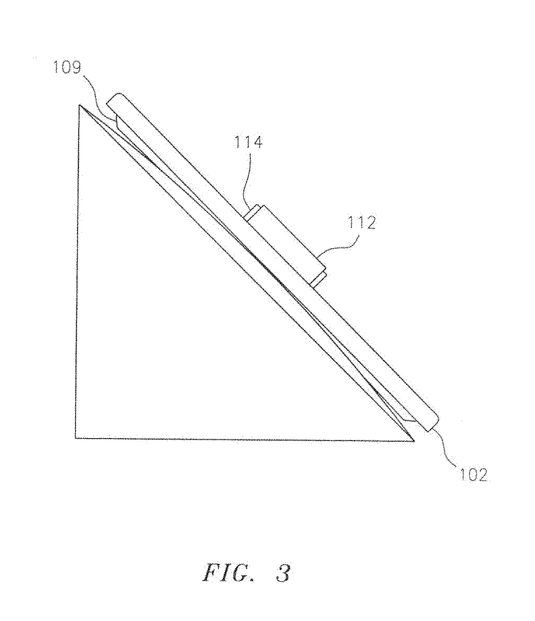

The surface contacting side 104 contact the surface on which the assembly is used, such as the non-limiting examples of a vehicle interior or dashboard, and is secured to the surface by the use of the air pocket section 106 which is compressed onto the surface and is assisted in its adherence to the surface by the adhesive 109, on the surface contacting side, which can be any type of adhesive, such as the non-limiting examples of permanent or, more preferably removable adhesives such as silicone adhesives. Other types of adhesives that may be employed are acrylates, cyanoacrylates, polyurethanes, latexes, and any composition of matter which would provide suitable adhesive force to maintain the entire assembly affixed to the dash. Such force should be sufficient to maintain an electronic device of the weight of anywhere from 0.1 pounds up to 5 pounds, preferably from 0.5 to 4 pounds and most preferably from 1 pound to 3 pounds, including any covers, or other mounting mechanisms inherent to the device. The tabs 108 are located on the circumference of the suction cup 102 and function to allow easy removal of the device from the surface by providing for easy breaking of the suction cup seal and adhesive effect of the adhesive 109. The application of the suction cup to a curved surface is shown in FIG. 3.

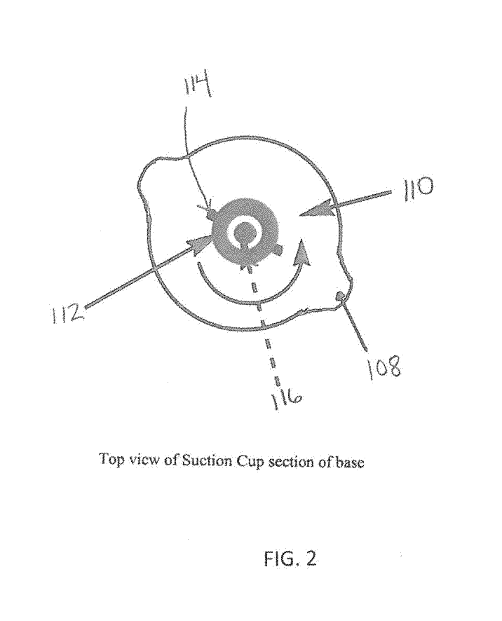

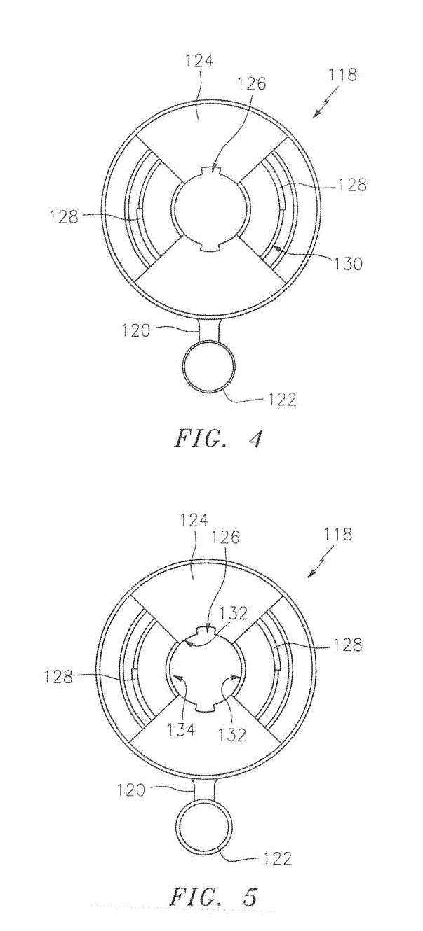

On the suction cup mount top side 110 which is shown in FIG. 2 there is provided a suction cup top ring 112 which protrudes in a uniform manner from the base surface of the suction cup mount top side 110 and which top ring 112 has a diameter which is less than that of the diameter of the suction cup top side 110 diameter, and preferably is from 1/10 to ½ the diameter. Inside the top ring 112 is a suction cup top interior ring post 116 and located in directly opposite points on the circumference of the top ring 112 are at least two suction cup top ring protrusions 114 which are each of the same length and also the protrusions 114 are of the same height as the top ring 112, and extend out from the ring to the extent necessary to engage the internal rotatable component shown in FIGS. 4-6.

FIGS. 4-6 demonstrate how the internal rotatable component 118 is laid out on its back (its base side 124) with the rod 120 and the ball 122 facing down into the page. There are two sets of interlocking mechanisms employed in the base section 100 of the assembly herein, the first being the interlocking mechanism of circumferential finger 128 and outer internal ring 130 shown in FIG. 4, to provide for interlocking of the capping component 140 with the internal rotatable component 118.

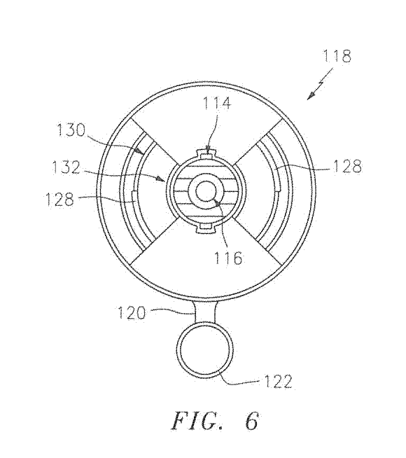

The second interlocking mechanism is the interlocking mechanism of internal circumferential finger 132 and inner internal ring 134 shown in FIGS. 5-6 to provide for interlocking of the suction cup mount 102 to the internal rotatable component 118. Both interlocking mechanisms function to connect the two interconnecting adjacent components of the assembly and simultaneously to apply a pressure downwards to the suction cup 102 so as to provide an adhesive force to the surface to which the assembly is applied.

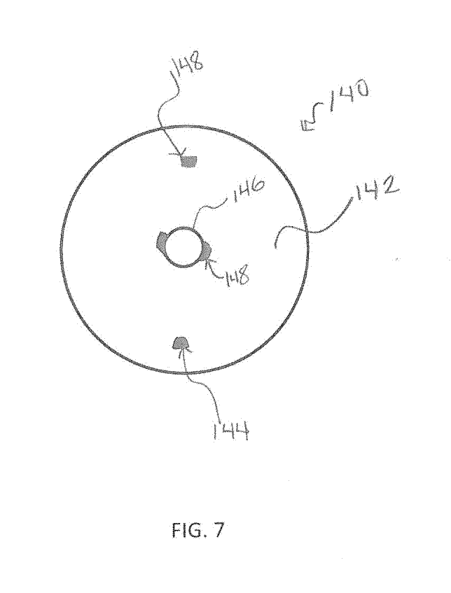

FIG. 4 shows how the base side 124 of the internal rotatable component 118 contains divets 126 configured to receive and accommodate the at least one suction cup top ring protrusions 114 shown in FIG. 2. In one non-limiting embodiment herein the base side 124 of the internal rotatable component 118 contains at least one circumferential FIG. 128 disposed in an arc parallel to the outside of the circumference of the outer internal ring 130, such that when the circumferential finger 128 is pulled in a direction opposite the surface to which the assembly is applied upon an interlocking of the capping component 140 shown in FIG. 7 with the internal rotatable component 118, (by the interlocking of the capping component internal ring extension 146 (FIG. 7) with circumferential finger 128 when the capping component 140 is rotated) and wherein the circumferential finger 128 is so angled and is of sufficient pliability so that its pulling in a direction opposite the surface upon interlocking of the capping component 140 (FIG. 7.) is such that it transmits pressure towards the surface of the entire base section 100 of the assembly upon said interlocking.

FIGS. 5-6 shows how the base side 124 of the internal rotatable component 118 contains at least one internal circumferential finger 132 disposed in an arc parallel to the outside of the circumference of an inner internal ring 134, wherein the internal circumferential finger 132 is pulled in a direction opposite the surface to which the assembly is applied upon an interlocking of the suction cup mount 102 shown in FIG. 1 with the internal rotatable component 118, (by the interlocking of the suction cup top ring protrusions 114 with the internal circumferential finger 132 when the internal rotatable component 118 is rotated) and wherein the internal circumferential finger 132 is so angled and is of sufficient pliability so that its pulling in a direction opposite the surface upon interlocking of the internal rotatable component 118 with the suction cup top ring protrusions 114 is such that it transmits pressure towards the surface of the entire base section 100 of the assembly upon said interlocking.

FIG. 7 shows that the capping component 140 of the base section 100 has an inner side 142 containing at least two capping component protrusions 144 effective to interlock with the internal rotatable component 118 and a capping component internal ring extension 146 with threading thereon 148 wherein the capping component internal ring extension 146 is of sufficient length that it is capable of inserting through the internal rotatable 118 and into the suction cup top ring 112 which can have suitable compatible threading thereon for receiving the threading 148 of the capping component internal ring extension 146. The interlocking of capping component 140 with the internal rotatable component can be such that the interlocking mechanisms described above, do not over-rotate and potentially destroy the circumferential fingers 128 and 132. This can be accomplished in one embodiment by containing the rotation of the capping component 140 to a specific limited arc of the circumference of the capping component 140. Such can be achieved by leaving a gap in the circumference of the capping component 140 which would stop the rod 120 from extending beyond a predetermined are when the cap 140 is rotated, by having a gap in the vertical sidewalls of capping component 140, which sidewalls while not shown in FIG. 7, would encompass the circumference of the capping component 140 wherein such walls extend out of the page in FIG. 7 in a circumferential fashion except for the previously noted gap in such a circumference. In one non-limiting embodiment the gap in the circumference of the sidewalls of capping component 140 can be from 90° to 180°, preferably from 100° to 150°, and most preferably about 120°.

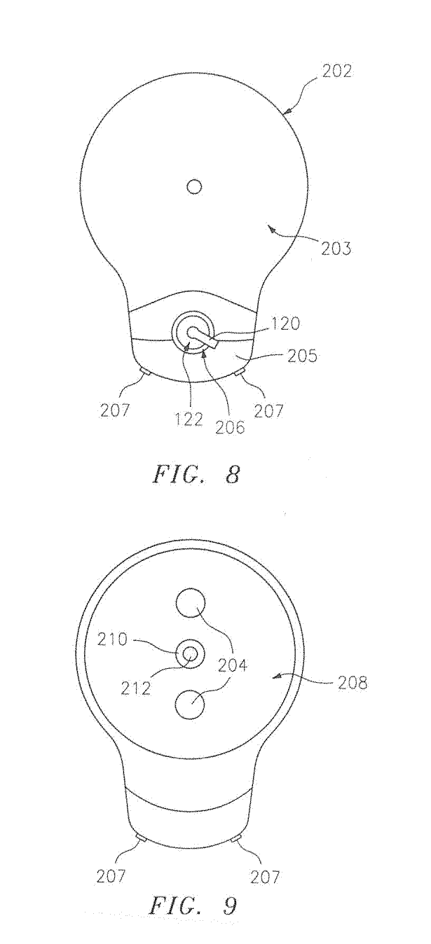

FIG. 8 shows the configuration of the rear side 203 of the rear cap 202, which contains the ball 122 extending from the rod 120 in a cavity 206 which partially encapsulates the ball 120 in an amount such that the ball 120 can rotate up to 120°. The ball 120 can be inserted into the cavity 206 by removing a removable section of the rear cap 205 to provide access to the cavity 206 by removing and then securing screws 207 retaining the removable section of the rear cap 202.

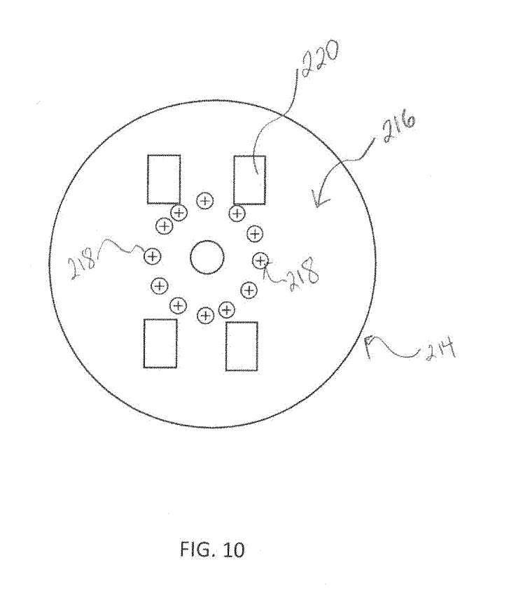

FIG. 9 shows the side of the rear cap 202 of the device mounting section 200 opposing the ball encapsulation side, i.e., the internal face of the rear cap 208. Ball bearings 204 can be seated in place in the internal face of the rear cap 208 by being seated in a tip of a hollow column beneath the ball bearing 204 (column not shown). The internal face of the rear cap 208 also contains a rear cap central internal column 210 containing therein affixing means 212 for affixing the rear cap 202 to the interior rotatable disc 214 (shown in FIG. 10) of the device mounting section 200. The affixing means 212 may comprise any conventional method such as any of a pin, a fastener, a screw, a nail, a pin and dowel, etc. Thus, upon rotation of the interior rotatable disc 214, the ball bearings 204 which are seated in the tips of the columns rotate in a staggered manner through contact with the circumferentially staggered divets 218 in the diveted side 216.

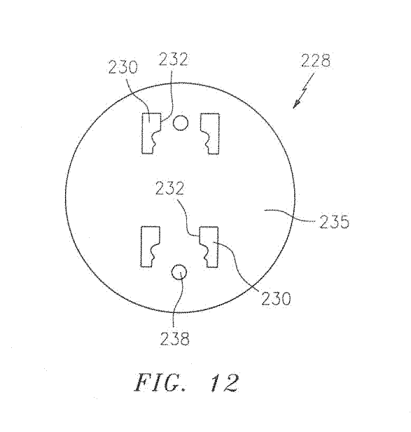

FIG. 10 shows the interior rotatable disc 214 with its circumferentially diveted side 216 containing divets 218 which diveted side 216 also contains cavities 220 which cavities 220 can interlock with the solid corresponding extendable portions 232 of cavities 230 in the opposing side containing receptacles 235 of the device contacting component 228 (FIG. 12).

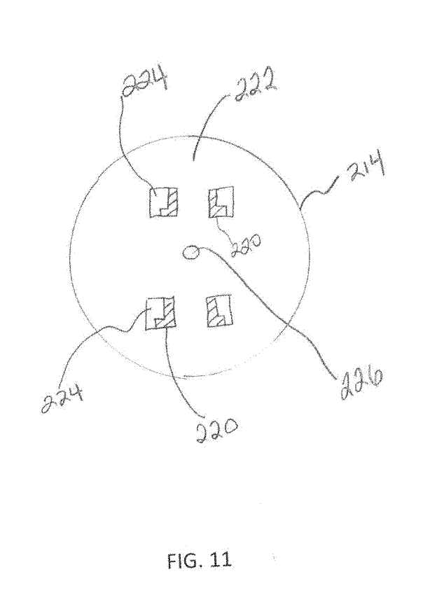

FIG. 11 shows the opposing side 222 of the interior rotatable disc 214 which opposing side 222 contains solid protrusions 224 and access to cavities 220 in the diveted side 216 of the interior rotatable disc 214. The opposing side 222 of the interior rotatable disc 214 can also contain a centrally located hole 226 which can access the affixing means 212 of the rear cap central internal column 210 (FIG. 9).

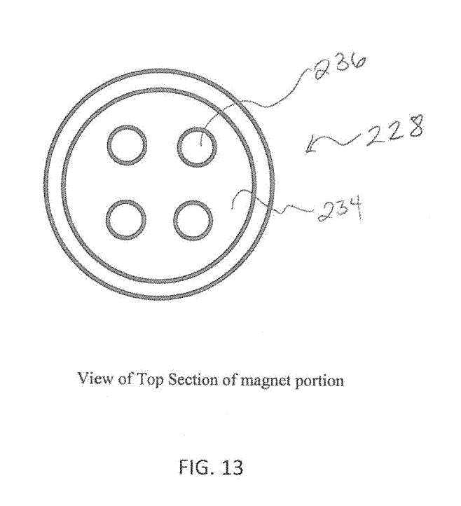

FIG. 12 shows the opposing side 235 having receptacles 230 which are configured to have extendible portions 232 thereof, which are engageable with the engageable protrusions 224 from the interior rotatable disc 214 (FIG. 11) and through the cavities 220 located there under and are configured to interlock with the side of said cavities 220 on the diveted side 216 of the interior rotatable disc 214 (FIG. 10). In addition, the opposing side 235 of the device contacting component 228 (FIG. 12) also contains at least one attachment hole 238 through which the opposing side 235 can be attached to the supermagent side 234 (FIG. 13) of the device contacting component 228.

In one non-limiting embodiment herein the supermagnet side 234 containing supermagnets 236 of the device contacting component 228 is covered with an adhesively applied cloaking material (not shown) which can be any suitable material, such as the non-limiting examples of felt, paper, plastic etc, and wherein the adhesive is any of those described herein.

FIG. 18 shows the entire assembly including the base section 100, the device mounting section 200 and the power supply retention component 300. In one embodiment herein the device mounting section can be rotated at least 360°, that is to say in FIG. 18, the circular structure shown in the device mounting section 200 can be rotated as shown by the arrows therein in either direction, and such circle of the device mounting section 200 represents the combination of the interior rotatable disc 214 and the device contacting component 228 bound together with the interlocking means described herein such that the rear cap 202 remains in place while the super magnet side 234 rotates in said circular fashion.

Likewise, with reference to FIG. 18, the base section 100 is rotatable in a plane parallel to the surface to which the base section 100 is applied (shown by the arrows around base section 100) up until the maximum rotation set by the arced gap in the sidewalls of the capping component 140 of the base section 100, as described above, and is preferably at least 120°.

In FIG. 14-18 the power supply retention component 300 is a clip with a connected thinner portion 302 and thicker portion 304, which clip 300 can function to at least substantially retain the power supply delivery means 306 therein. In one embodiment the power supply delivery means 306 can be a cable for an electronic device, such as the non-limiting examples of a cellular telephone or GPS device. The power supply retention component 300 can optionally contain a base 301.

While the invention has been described with reference to certain embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed as the best mode contemplated for carrying out this invention but that the invention will include all embodiments falling within the scope of the appended claims

1. An assembly for removeably mounting an electronic device to a surface, said assembly comprising:
a) a base section comprising
i) a suction cup mount removeably attachable to a surface,
ii) an internal rotatable component having a rod projecting therefrom and a ball affixed to the rod, and
iii) a capping component,
wherein internal rotatable component a (ii) is configured between suction cup mount a(i) and capping component a(iii), and
wherein capping component a(iii) is engageably connected to internal rotatable component a(ii) such that circumferential rotation of the capping component a(iii) in a parallel plane relative to the surface results in a pressure being applied to the internal rotatable component a(ii) and also the suction cup mount a(i) in the direction perpendicular to the surface, such that suction cup mount a(i) is affixable to the surface by such circumferential rotation;
b) a device mounting section comprising
i) a rear cap containing at least two ball bearings seated therein and a cavity for at least partially encapsulating the ball from a(ii) to provide for connection of base section (a) to device mounting section (b) and to provide for at least 120° of rotation of device mounting section (b) relative to base section (a),
ii) an interior rotatable disc having a circumferentially diveted side to provide for seating of the ball bearing in rear cap b) (i) and an opposing side having at least two engageable protrusions therefrom, and
iii) a device contacting component having a side containing at least one supermagnet therein, and an opposing side containing receptacles configured to receive engageable protrusions from interior rotatable disc b) (ii),
wherein interior rotatable disc b (ii) is configured between rear cap b(i) and device contacting component a(iii), and
wherein circumferential rotation of device contacting component b (iii) results in a segmented movement of the seated ball bearings in b) (i) against the diveted side of b(ii); and,
c) a power supply retention component attached to the base section (a) which releaseably attaches a power supply delivery means thereto.

2. The assembly of claim 1 wherein the suction cup mount contains an adhesive on the surface contacting side.

3. The assembly of claim 1 wherein the suction cup mount contains at least one tab on the circumference of the suction cup for removeably detaching the suction cup from the surface.

4. The assembly of claim 1 wherein the suction cup mount has a side opposing the surface contacting side which contains a top ring of smaller diameter than that of the surface cup mount diameters and which contains at least one ring protrusion extending from the side of the ring.

5. The assembly of claim 4 wherein the internal rotatable component has a base side which faces the suction cup top side and which contains divets which can accommodate the at least one suction cup top ring protrusion.

6. The assembly of claim 5 wherein the base side of the internal rotatable component contains at least one circumferential finger disposed in an arc outside the circumference of an outer internal ring, wherein the circumferential finger is pulled in a direction opposite the surface upon an interlocking of the capping component with the internal rotatable component, and wherein the circumferential finger is so angled and is of a sufficient pliability so that its pulling in a direction opposite the surface upon interlocking of the capping component is such that it transmits pressure towards the surface to the entire base section upon said interlocking.

7. The assembly of claim 5 wherein the base side of the internal rotatable component contains at least one internal circumferential finger disposed in an arc outside the circumference of an inner internal ring, wherein the circumferential finger is pulled in a direction opposite the surface upon an interlocking of the capping component with the internal rotatable component, and wherein the inner circumferential finger is so angled and is of a sufficient pliability so that its pulling in a direction opposite the surface upon interlocking of the internal rotatable component with the suction cup top ring protrusions is such that it transmits pressure towards the surface to the entire base section upon said interlocking.

8. The assembly of claim 1 wherein the capping component of the base section has an inner side containing at least two capping component protrusions effective to interlock with the internal rotatable component and a capping component internal ring extension with threading thereon wherein the capping component internal ring extension is of sufficient length that it is capable of inserting through the internal rotatable component and into the suction cup top ring which can have suitable compatible threading therein for receiving the threading of the capping component internal ring extension.

9. The assembly of claim 1 wherein the cavity in the rear cap of the device mounting section is such that it provides for encapsulation of the ball from the internal rotatable component of the base section in an amount such that the rod can rotate up to 120°.

10. The assembly of claim 9 wherein the ball extending from the rod of the internal rotatable component of the base section can be inserted and encapsulated into the cavity in the rear cap of the device mounting section by removing a removable section of the rear cap to provide for access to the cavity by removing and then securing screws retaining the removable section of the rear cap.

11. The assembly of claim 1 wherein the side of the rear cap of the device mounting section opposing the ball encapsulation side contains the ball bearings seated in the tip of accompanying rear cap ball bearing hollow columns, and also contains a rear cap central internal column containing therein affixing means for affixing the rear cap to the interior rotatable disc.

12. The assembly of claim 1 wherein the interior rotatable disc having a circumferentially diveted side also contains cavities which can interlock with corresponding extendable portions of cavities in the opposing side containing receptacles of the device contacting component.

13. The assembly of claim 1 wherein the opposing side of interior rotatable disc contains protrusions and access to cavities in the diveted side of the interior rotatable disc and also contains a centrally located hole which can access the affixing means of the rear cap central internal column.

14. The assembly of claim 1 wherein the opposing side of the device contacting component contains receptacles which are configured to have extendible portions thereof which are engageable with the engageable protrusions from the interior rotatable disc and through the cavities located thereunder and to interlock with the side of said cavities on the diveted side of the interior rotatable disc.

15. The assembly of claim 14 wherein the opposing side of the device contacting component also contains an attachment hole through which the opposing side can be attached to the super magnet side.

16. The assembly of claim 1 wherein the super magnet side of the device containing component is covered with an adhesively applied cloaking material.

17. The assembly of claim 1 wherein the device containing component is capable of rotating at least 360°.

18. The assembly of claim 1 wherein the base section is rotatable in a plane parallel to the surface of at least 120°.

19. The assembly of claim 1 wherein the power supply retention component is a clip with a connected thinner and thicker portion which clip can function to at least substantially retain the power supply delivery means therein.

20. The assembly of claim 19 wherein the power supply delivery means is a cable for an electronic device.

21. The assembly of claim 20 wherein the electronic device is a cellular telephone.

22. The assembly of claim 21 wherein the electronic device is a GPS device.

23. A process of quickly mounting and powering an electronic device to a surface comprising employing the assembly of claim 1 and a power supply means releasably attached to the power supply retention component.
